(19) United States
(12) Patent Application Publication
(10) Pub. No.: US 2004/0039803 A1
(43) Pub. Date: Feb. 26, 2004

(54) Unified policy-based management system

(76) Inventor: Eddie Law, North York (CA)

Correspondence Address: David J. Greer, c/o Ridout & Maybee LLP, Suite 2400, One Queen Street East, Toronto, ON, M5C 3B1, CA

(21) Appl. No.: 10/224,655

(22) Filed: Aug. 21, 2002

(51) Int. Cl. G06F 15/173

(52) U.S. Cl. 709/223

(57) ABSTRACT

A unified policy-based network management method and system for enforcing QoS defined by policy rules at a network node. The network management system employ a Policy Enforcement Agent (PEA) responsible for capturing a policy rule in flight and translating the policy rule to actual policy enforcement action executable at a network node.

### FIELD OF THE INVENTION

The present invention relates generally to policy-based management of a network, and more particularly, to policy administration and enforcement in a Quality of Service (QoS) driven network.

### BACKGROUND OF THE INVENTION

With the exponential proliferation of the Internet has come a wide range of end-user applications such as IP telephony, real-time video teleconferencing and multimedia data streaming. The accelerated growth of these content-rich applications is placing a new level of demand on network resource management. The complexity of managing various applications in a network is further exacerbated by the particular QoS requirements of the end-user applications. Accordingly, there is a huge interest to ensure that the limited network resources are used efficiently, and that the different QoS classes particular to the end-user applications are managed optimally.

To manage and administer different QoS classes in a network, policy driven network management schemata have been proposed. In policy-based management (PBM) schemes, different levels of services are assigned with different policies or directives. These policies define the criteria for resource access and usage. Various variables, such as the time spent waiting for data to be transferred, or other application specific aspects such as jitter, quality of playback, quality of data transferred across the Internet may be used to measure and determine the QoS provided to a network subscriber.

Typically in existing proposals, a two-tiered PBM model 100 has been deployed. As shown in FIG. 1, the two-tiered PBM model 100 essentially comprises a Policy Server (PS) 104 communicating policy rules or directives to a number of network subscribers 106a, 106b through corresponding network node 111 in a policy administrative domain. To achieve this, the two-tiered model defines two architectural elements: (i) Policy Decision Point (PDP) 110; and (ii) Policy Enforcement Point (PEP) 112. PEP 112 is a component at the network node 111 such as an edge router (or a boundary router) wherein policy rules or directives are enforced. PDP 110 is a remote entity generally residing in the PS 104 and is responsible for making decisions on policy requests based on policy rules generally stored in the PS 104. The PDP 110 uses a Lightweight Directory Access Protocol (LDAP) proposed by the Internet Engineering Task Force (IETF) to fetch the stored policy rules in the PS 104 database. Communication between PDP 110 and PEP 112 is accomplished by the Common Open Policy Service (COPS) protocol for policy outsourcing, and its extension, the COPS-PR for policy provisioning, as advanced by the IETF.

The two-tiered PBM model 100 employs the popular Transmission Control Protocol/Internet Protocol (TCP/IP) for communicating data amongst various network elements. Currently, the TCP/IP protocol suite provides only “best effort” service delivery, and does not ensure timely delivery or provide any QoS guarantees about data throughput. As a result, even in a lightly loaded TCP/IP network, delivery delays can vary enough to adversely affect applications having QoS requirements. Accordingly, the Internet Protocol is generally complemented with the Differentiated Services (DiffServ) or the Integrated Services (IntServ) architectures proposed by IETF to provide QoS provisioning for various end-user applications running on the network subscribers 106a, 106b.

One difficulty associated with the two-tiered PBM model 100 is scalability in heterogenous networks. Since the current model uses the standard COPS protocol for policy-related communications between the PDPs and PEPs, the two-tiered PBM model 100 requires fundamental changes to the underlying network structure and cannot be implemented on existing heterogeneous network platforms that use other protocols or different variations of the COPS protocol.

Furthermore, the two-tiered model is not designed with a view of providing load-sharing load-balancing mechanisms. This can be problematic in a large scale network with variable points of congestion, as the PEP 112 would keep tying to connect to a corresponding PDP 110, waiting for a timeout between each try.

Another drawback associated with the current two-tiered scheme is that legacy equipments are not readily supported by the proposed model. To participate in a new policy management scheme, legacy equipments often need to be upgraded or replaced. This in turn severely affects the deployment of QoS in existing networks, as the cost for upgrading or replacing the legacy equipments may become prohibitive in a large scale network.

Accordingly, an important challenge in PBM in a heterogenous network resides in providing seamless policy instructions to various end-user applications having different QoS requirements, without the need to adapt and update the legacy equipments to achieve QoS provisioning and outsourcing to various network subscribers in the network.

### BRIEF SUMMARY OF THE INVENTION

The present invention provides an improved multi-tiered policy management system for monitoring, enforcing, and controlling QoS.

The present invention arises from the realization that network scalability and QoS implementation in network equipment in existing PBM systems is improved by a multi-tiered PBM architecture, whereby policy communication between a PS and a network node is achieved through the intermediary of a Policy Enforcement Agent (PEA) responsible for capturing a policy rule in flight and translating the policy rule to actual policy enforcement action executable at a network node. Similarly, a policy request initiated at a network node is intercepted at the PEA and translated into a network protocol which is understandable at the PS. The PEA is transparent to all network equipment and functions as a PDP when communicating with network nodes, and as a PEP when interacting with the PS. As a result, the unified PBM model is readily scalable with existing network systems as they evolve and is extensible to network equipments with no upgrade requirements.

In one aspect, the present invention provides a method of network management in a network having a plurality of networked subscribers logically connected to one another through network nodes wherein a QoS (Quality of Service) provided to the network subscribers is determined by policy rules, the method comprising the steps of:

(a) selecting a policy rule containing QoS information for a network subscriber;

(b) translating the policy rule into instructions understandable by a network node associated with the network subscriber; and

(c) sending the translated policy rule to the network node.

In another aspect, the present invention provides a method of network management in a TCP-IP network having a plurality of networked subscribers logically connected to one another through network nodes wherein a QoS (Quality of Service) provided to the network subscribers is determined by policy rules, and the network nodes and the network subscribers communicate with one another using a same network protocol, the method comprising the steps of:

(a) storing a plurality of policy rules in a policy repository;

(b) accessing the policy repository by a policy server;

(c) selecting a policy rule containing QoS information for a network subscriber;

(d) creating a persistent connection between the policy server and a network node associated with the network subscriber; and

(e) sending the policy rule to the network node through the persistent connection.

In another aspect, the present invention provides a policy-based networking management system for managing QoS provisioning to various network subscribers. The policy-based networking management system comprises a policy repository containing a plurality of policy rules defining QoS requirements for a network subscriber associated with a network node in a policy domain, and a policy server (PS) having means for retrieving a policy rule from the policy repository wherein the policy rule corresponding to a policy request by the network node. The policy-based networking management system also includes a policy enforcement agent (PEA) in dialogue with the PS and the network node, the PEA having means for intercepting a policy request initiated by the network node, the PEA having further means for communicating the policy rule to the PS, and means for executing the policy rule at the network node.

In yet another aspect, the present invention provides a computer-readable medium carrying one or more sequences of instructions for managing a network according to a plurality of network management policies. The computer-readable medium comprises means for establishing bi-directional policy communication between a policy server and a network node, means for validating a policy request from a network node, means for accessing the policy server to fetch a policy rule corresponding to the policy request, and lastly means for translating the policy rule into machine language understandable by the network node.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings, which show, by way of example, an embodiment of the present invention, and in which:

FIG. 1 is a diagrammatic view of a policy-driven network architecture;

FIG. 2 is a diagrammatic view of a three-tiered unified policy management (UPM) model according to an embodiment of the present invention;

FIG. 2(a) is a diagrammatic view of policy communication in UPM wherein the network node employs a non-COPS protocol according to an embodiment of the present invention;

FIG. 2(b) is a diagrammatic view of policy communication in UPM wherein the network node employs a non-native COPS protocol according to another embodiment of the present invention;

FIG. 2(c) is a diagrammatic view of policy communication in UPM illustrating the TCP by-pass mechanism according to another embodiment of the present invention; and

FIG. 3 is a schematic diagram of an illustrative embodiment of a network employing the three-tiered UPM system of the present invention.

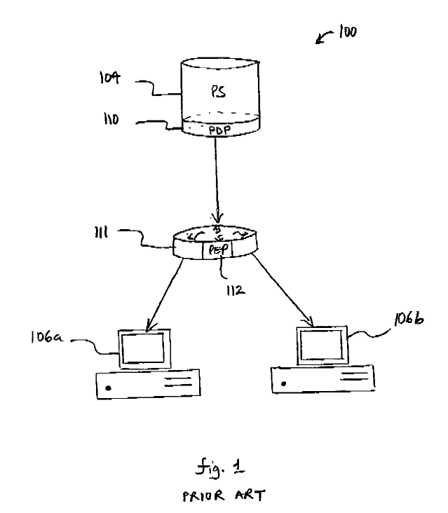

### DETAILED DESCRIPTION

The present invention is now described with reference to accompanying drawings, wherein like reference numerals denote like constituent elements throughout the drawings.

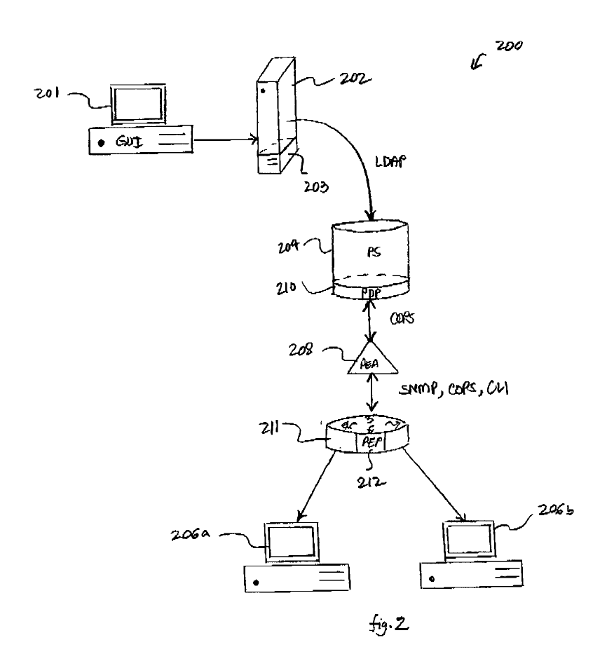

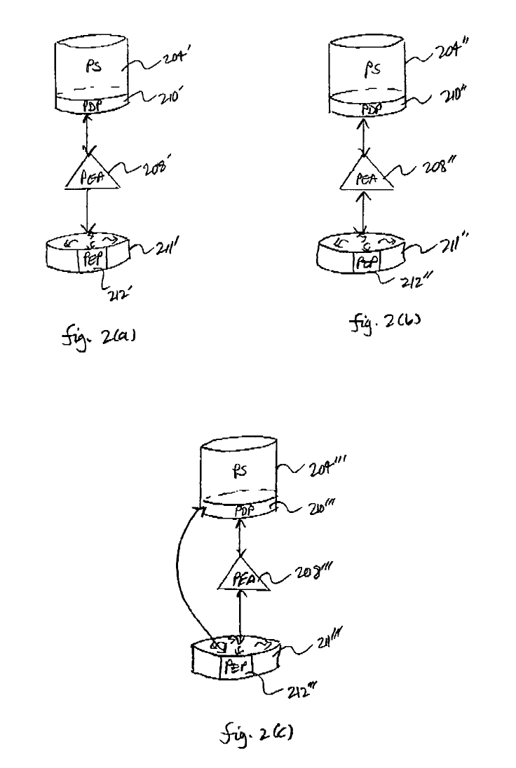

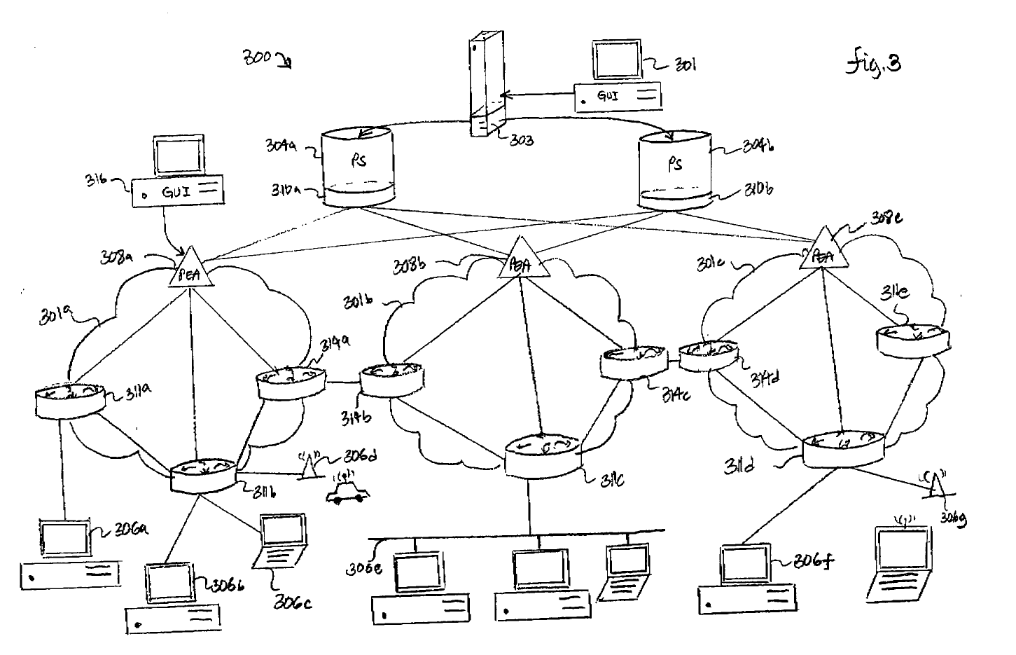

Reference is made to FIG. 2, which shows a three-tiered unified policy management (UPM) model in accordance with the present invention. Although the UPM model as described in FIG. 2 includes two network subscribers, it can be appreciated that UPM model could be expanded to include a plurality of network subscribers without changing the basic functionality of the underlying network. Furthermore, the general concept of the invention may be extended to a number of layers, thereby providing for a multi-tiered policy management scheme.

The UPM model 200 as shown in FIG. 2 includes an LDAP server 202 for saving policy rules in a policy repository 203. The LDAP server 202 can be directly accessed by a network administrator or technician for input by means of a policy editing tool such as a Graphical User Interface (GUI) 201 connected to the LDAP server 202, having the capabilities for translating high-level human commands into various policy rules. These policy rules are stored in Policy Information Base (PIB) and typically consist of (1) a set of network conditions such as user name, network addresses, network protocols and application types under which the policy rule applies; and (2) a set of network actions that are performed as a consequence of satisfying or not satisfying the conditions, such as bandwidth guarantees, wireless access control, service load-balancing, cache redirection or data routing. For instance, a network administrator may identify a particular end-user application as a “gold” QoS class application, thereby granting the gold QoS class application the highest level of service priority throughout the policy administrative domain through conflict detection and resolution mechanisms.

The policy repository 203 generally comprises a directory database for the storage wherein the stored policy rules in a specific controlled policy administrative domain are stockpiled and saved. These policy rules are accessed by a policy server (PS) 204 to validate them against a policy request from an end-user application. Policy communication between the LDAP server 202 and the PS 204 is typically achieved using the IETF proposed LDAP or other similar network communication protocols. Advantageously, a unified information model may be employed between the LDAP server 202 and the PS 204 which uses Extensible Markup Language (XML) to operate on the LDAP server 202. As a result, whenever the design of the Policy Information Base (PIB) is changed at the PS 204, the XML can be used to update the changes instantly at the PS 204.

The PS 204 includes a policy decision point (PDP) 210 for handling policy requests initiated by end-user applications running on network subscribers 206a, 206b. Accordingly, when a specific policy request is solicited by an end-user application running on the network subscriber 206a, the PDP 210 accepts the policy request, accesses the stored policy rules in order to retrieve the policy request, validates and pushes the requested policy rule to a Policy Enforcement Point (PEP) 212 which belongs to a Policy Enforcement Agent (PEA) 208 in this proposed design for policy enforcement. The PDP 210 employs, in the presently described embodiment of the invention, the COPS protocol to coordinate policy communications with the PEA 208.

The PEA 208 is used to enforce policy rules or directives within the context of the particular end-user application. The PEA 208 is typically a software entity which may reside directly on the managed device or system, or it may reside on some other system. Essentially, the PEA 208 serves as remote active management component which executes policy decisions to be executed locally at a policy enforcement point (PEP) 212 for a particular network node 211 responsible for providing network services to network subscribers 206a, 206b. The network node 211 is typically a router or a network equipment that locally consolidates and analyzes the network conditions to perform network actions as required by the end-user applications running on a network subscriber 206a or 206b.

The PEA 208 generally administers and monitors all policy rules for the benefit of the network node 211. Specifically, the PEA 208 communicates the policy rule between the PS 204 and the network node 211. Accordingly, the PEA 208 performs both outsourcing events as well as one-way decision provisioning, by either receiving a policy request from a network node 211 or a policy rule issued from the PS 204.

The PEA 208 also translates the policy rule that is carried by a network protocol that the network node 211 can understand, and ensures that QoS based on the policy rule is maintained at the network node 211. Additionally, the PEA 208 may also perform the task of informing the network node 211 of the existence of other PEAs (not shown) in the same policy administrative domain.

The PEA 208 employs the inherent features of the COPS protocol to report to the PDP 210 that a policy decision has been successfully performed locally, regardless of the type of the network subscriber 206a, 206b. In the presently described embodiment of the invention, communication between the PEA 208 and the PEP 212 at the network node 211 is achieved using COPS. If the network node 211 does not employ COPS, it may communicate with the PEA 208 using the Simple Network Management Protocol (SNMP), Command Line Interface (CLI) or other similar network protocols.

An important function of the PEA 208 is to translate COPS commands into a language corresponding to the native COPS version and format employed in the PS 204. Reference is now made to FIGS. 2(a), (b) and (c), wherein different types of network connections between the network node 211 and the PS 204 are illustrated. There is shown in FIG. 2(a) a COPS PS 204′ having a PDP 210′ connected to a non-COPS network node 211′ through a PEA 208′. This type of network node 211′ is typically a ‘push’ or ‘pull’ only router which needs to be configured to provide networking operations to a network subscriber (not shown). The PEA 208′ includes a translation module (not shown) for opening a new connection or using an existing connection with the PS 204′ in order to convert and communicate policy requests or decisions between the PDP 210′ and the network node 211′. Such translation module could be a software entity implemented at the PEA 208′, having translation routines which are accessed by the PEA 208′ and dynamically loaded as various non-COPS standard network nodes are further added to the network. In an alternative embodiment, various translation modules may be saved in a central database, whereby the modules may be shared amongst various PEAs. Preferably, a network protocol tool such as the Remote Method Invocation (RMI) in Java programming may be employed to load a module into the PEA.

FIG. 2(b) shows policy communication between a network node 211″ connected to a PS 204″ through the intermediary of a PEA 208″, wherein the network node 211″ employs a different version of the COPS protocol. Even if the COPS implementation at the network node 211″ is compliant to the standard version, the policy message structures may be different from one another, especially, different vendors may have different proprietary policy message structures and content designs. Accordingly, given a proper translation module, the COPS messages need to be translated into a format comprehensible to the COPS compliant network node 211″. The network node 211″ may have one specified translation module, which can be dynamically loaded in the PEA 208″. For non-standard implementations of COPS at the network node 211″, the PEA 208″ employs the same technique as described for the non-COPS network node 211′ of FIG. 2(a), namely, to intercept the COPS policy message at the PEA 208″ and provide policy provisioning or outsourcing using an existing or a new connection to the PS 204″. For COPS-compliant implementation at the network node 211″, the COPS policy messages are converted and forwarded by the PEA 208″ to the network node 211″ as required.

FIG. 2(c) shows policy communication between a network node 211′″ and a PS 204′″, where the network node 211′″ uses the same COPS version and interpretable policy content as the PS 204′″. Under such circumstances, COPS message translation is no longer a requirement, and the PEA 208′″ may also include an expedited network data transfer bypassing mechanism to remove unnecessary translation overhead and reduce latency at the PEA 208′″. Accordingly, in a TCP/IP based network system where the network node 211′″ and the PS 204′″ communicate using the COPS protocol, information can be relayed though the TCP layer directly between the network node 211′″ and the PS 204′″ without any intervention from the PEA 208′″. This in turn frees up some of the resources available at the PEA 208′″, which may now carry out other functions such as monitoring the traffic loading between other network nodes (not shown) and the PS 204′″. The TCP bypass mechanism has enhanced capabilities to re-route data transfer between the PS 204′″ and the network node 211′″ through a persistent connection. Generally, data packets containing COPS messages are passed between the PS 204′″ and the network node 211′″ according to previously established TCP sessions. To achieve seamless policy communication by TCP bypass, COPS version and implementation signature is first determined based on the information contained in a COPS data packet. Extensible messages may be designed for providing content version interpretation. Once the COPS version and signature implementation is verified to match to those at the PS 204′″ and the network node 211′″, a new TCP session between the PS 204′″ and the network node 211′″ is established by the PEA 208′″ to directly transfer policy requests solicited by the network node 211′″ and policy decisions from the PS 204′″ en route to the network node 211′″, thereby providing a transparent connection between the PEP 212′″ and the PDP 210′″ without any further intervention by the PEA 208′″.

Advantageously, apart from a field that indicates the version of the COPS protocol, COPS command messages may be extended to include a field that depicts the content versions within the COPS messages. With this extension, the PEA 208′″ is able to determine if the PS 204′″ and the network node 211″ can understand each other. If PS 204″ and network node 211′″ can communicate with identical version of COPS and with understandable content information as contained in the COPS messages, then the primary role of the PEA 208′″ is load monitoring and exercising load sharing mechanisms. In this situation, the TCP-bypass mechanism operating at the PEAs 208′″ ensures that all subsequent COPS messages, after the initial COPS message, are delivered at the TCP transport layer without wasting extra processing power of the PEAs to undergo higher layer operations and interpretations.

Referring back to FIG. 2 and based on the foregoing, it can be appreciated that the three-tiered UPM architecture distributes the load between three different layers, namely; the top-tier, wherein policy rules are saved by the LDAP server 202 in the policy repository 203 and retrieved by the PS 204; the middle-tier, comprising the PEA 208 for coordinating policy communications between the PS 204 and various network subscribers 206a, 206b; and the bottom-tier including the network node 210 where policy decisions are executed. Advantageously, communication between the PEA 208 and a network node 201 is not confined to a specific network protocol. Accordingly, PEA 208 can be tailor-made to accommodate various types of network equipments, notwithstanding the particular version or type of the network protocol currently employed by the network equipment.

Reference is next made to FIG. 3, which shows a network 300 in a policy administrative domain employing the three-tiered unified policy management system. Network 300 typically includes the policy administrative subdomains 301a, 301b 301c providing QoS traffic to various network subscribers 306a, 306b, 306c and 306d, 306e, 306f and 306g. The policy administrative subdomains 306a, 306b, 306c are in communication with each other via routers 314a, 314b, 314c and 314d. In a hybrid network topology such as network 300, the network subscribers may consist of personal computers 306a, 306b and 306c, virtual private networking (VPN) 306e, or mobile hosts 306d, 306g. The network subscribers 306a to 306g maybe communicating data with each other or with various other network entities. For instance, network subscriber 306a may be communicating with network subscriber 306b in a video conferencing session.

Network 300 employs, in the presently described embodiment of the current invention, the TCP/IP network protocol complemented with the IETF-proposed DiffServ or IntServ architectures to provide QoS outsourcing and provisioning to various network subscribers 306a to 306g.

The QoS policy rules for end-user applications are created by a user such as a network administrator and entered into preferably one of the PSs 304a, 304b or 304c or otherwise a LDAP server 302. The LDAP server 302 may include a GUI component 301 that provides a user interface to monitor status of policy-managed environment, and to construct and deploy high-level policy instructions. These policy instructions contain the network conditions and actions defining QoS classes for end-user applications running on various network subscribers 306a to 306g. The LDAP server 302 translates high-level policy instructions into machine understandable language and populates an LDAP policy repository 303 generally residing therein.

Advantageously, the LDAP open source implementation as proposed by IETF may be employed to store policy instruction in the policy repository 303. Not only the LDAP policy repository 303 includes several back-end database options for storing the policy rules, it also provides tools to compile policy instructions from LDAP into a format suitable for storage in back-end databases.

PSs 304a, 304b generally coordinate policy communication between the network subscribers 306a to 306g and PDP 310a, 310b. Specifically, the PSs 304a, 304b each employ a PDP 310a, 310b for accepting a policy request from a network subscriber 306a to 306g, accessing the policy rules stored in the policy repository 303 in order to retrieve the requisite policy rule, validating the request and pushing the policy rule to PEAs 308a, 308b, 308c for policy enforcement.

The PSs 304a, 304b may be implemented as policy server programs written in C programming language. In an alternative embodiment of the present invention, a PS 304a, 304b or 304c is preferably able to accept newly input policy rules for immediate decision making and subsequent delivery to the policy repository 303 at the LDAP server 302. Policy communication between the PEAs 308a, 308b, 308c and the PDPs 310a, 310b is achieved, in the presently descried embodiment of the invention, using the COPS protocol.

The PEAs 308a, 308b, 308c generally include several network processing modules such as a database containing network addressing and connection information for corresponding network nodes 311a to 311e, a GUI interface 316 to allow a user to manually control network scheduling and modify the PEAs 308a, 308b, 308c setting, a loadable module server to adapt to new network nodes 311a to 311e, policy translation modules and scheduler module for policy enforcement at various network nodes 311a to 311e. The PEA modules may be implemented in C and Java programming language.

In operation, a policy request from an application running on a network subscriber 306a within the policy administrative subdomain 301a is sent to the corresponding network node 311a, and subsequently to a non-congested PDP 310a residing at PS 304a through the intermediary of the PEA 308a. At this stage, the PDP 310a accepts the policy request and accesses the pre-stored policy rules to fetch the policy rule determining the action to be taken at network node 311 a corresponding to the particular policy request based on current network conditions. The PDP 310a validates the policy request and forwards the decided corresponding policy rule to the PEA 308a. Upon receiving the policy rule, the PEA 308a looks up the information regarding the network node 311a if intermediate action is required. If the policy rule needs to be translated, the PEA 308a looks for the system module for this particular network node 311a to translate the policy rule into QoS action understandable by the network node 311a, and dispatches policy instructions to the network node 311a for policy enforcement

In an alternative embodiment, each PEA 308a, 308b, 308c learns the network identifiers for the PSs 304a, 304b and saves these network identifiers (such as the network address) in a table. Advantageously, a PEA 308a may include a protocol to dynamically recognize the presence of all available PSs 304a, 304b in a policy administrative domain. As a PS 304a registers with a PEA 304a, information about the special client type that the PS 304a can handle may also be collected by the PEA 304a and stored in the table. As a result, load balancing on a new network subscriber 306a can be restricted to a PS 304a which supports the specific client type for the new network subscriber 306a.

In an attempt to improve network resource allocation, the PEAs 308a, 308b, 308c may monitor various variables such as CPU usage, memory usage, link utilization or propagation delays at the PSs 304a, 304b to determine network congestion at each PSs 304a, 304b. Such information about the PSs 304a, 304b performance may also be saved into the table in realtime. Based on this information, the PEAs 308a, 308b, 308c assign different weighted parameters to different PSs 304a, 304b to alleviate heavy network traffic at a particular PS 304a, 304b by redirecting network policy activity to PSs 304a, 304b that are less busy based on advanced scheduling schemes such as Weighted Round Robin (WWR) or Class-based Queuing (CBQ).

In an alternative embodiment, a set of network messages are created for PSs 304a, 304b and PEAs 308a, 308b, 308c to inform their neighboring PSs 304a, 304b and PEAs 308a, 308b, 308c regarding the local loads. As a result, neighboring PSs 304a, 304b and PEAs 308a, 308b, 308c can determine the appropriate addressing when redirect messages are needed to be sent accordingly. The local loading at either PS 304a, 304b or PEA 308a, 308b, 308c is used to determine if a redirect message is needed to reply when a service/policy request is received. In order to avoid unnecessarily oscillations on selecting the best PS 304a, 304b or PEA 308a, 308b, 308c to serve a request, a loading threshold is used locally. When the local load is lower than the threshold, the service request will be served; otherwise, the network node 311a to 311e with the lowest load at that instance will be selected and replied with the redirect messages.

It is appreciated that the present invention provides a hierarchical system to coordinate and enforce various policy rules between the PSs 304a, 304b, the PEAs 308a, 308b, 308c and various network nodes 311a to 311e using a unified distributed approach. Since all policy-related information is required to pass through the PEAs 308a, 308b, 308c, network resources may be effectively monitored by supplying the policy-related information to the PSs 304a, 304b, to help them make appropriate decisions with respect to network resource management. Alternatively, the PEAs 308a, 308b, 308c may decide to issue COPS re-direct messages to those network nodes 311a, 311b, 311c soliciting new policy requests to transfer network traffic to an area that is less congested.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of network management in a network having a plurality of networked subscribers logically connected to one another through network nodes wherein a QoS (Quality of Service) provided to the network subscribers is determined by policy rules, comprising the steps of:
(a) selecting a policy rule containing QoS information for a network subscriber;
(b) translating the policy rule into instructions understandable by a network node associated with the network subscriber; and
(c) sending the translated policy rule to the network node.

2. The method of claim 1 further including:
(d) enforcing the policy rule at the network node to provide the network subscriber with QoS based on the QoS information contained in the policy rule.

3. The method of claim 2 wherein step (a) includes receiving a policy request from the network subscriber and selecting the policy rule that corresponds to the policy request from a plurality of policy rules.

4. The method of claim 3 wherein step (a) includes translating the policy request from the network subscriber.

5. The method of claim 2 including step (a), prior to storing the policy rule in a policy repository.

6. The method of claim 5 wherein step (a) further includes accessing the policy repository to select the policy rule contained therein.

7. The method of claim 2 wherein step (d) further includes monitoring the enforcement of the policy rule at the network node.

8. A method of network management in a TCP-IP network having a plurality of networked subscribers logically connected to one another through network nodes wherein a QoS (Quality of Service) provided to the network subscribers is determined by policy rules, and the network nodes and the network subscribers communicate with one another using a same network protocol, the method comprising the steps of:
(a) storing a plurality of policy rules in a policy repository;
(b) accessing the policy repository by a policy server;
(c) selecting a policy rule containing QoS information for a network subscriber;
(d) creating a persistent connection between the policy server and a network node associated with the network subscriber; and
(e) sending the policy rule to the network node through the persistent connection.

9. The method of claim 8 further including:
(f) enforcing the policy rule at the network node to provide the network subscriber with QoS based on the QoS information contained in the policy rule.

10. The method of claim 9 wherein step (c) includes receiving a policy request from the network subscriber and selecting the policy rule that corresponds to the policy request from the plurality of policy rules.

11. A policy-based networking management system, comprising;
a policy repository containing a plurality of policy rules defining QoS requirements for a network subscriber associated with a network node in a policy domain;
a policy server (PS) having means for retrieving a policy rule from the policy repository, the policy rule corresponding to a policy request by the network node;
a policy enforcement agent (PEA) in dialogue with the PS and the network node, the PEA having means for intercepting a policy request initiated by the network node, the PEA having further means for communicating the policy rule to the PS, and means for executing the policy rule at the network node.

12. The policy-based networking management system as set forth in claim 11 further comprising an LDAP server to populate an LDAP directory database of the policy repository with policy rules.

13. The policy-based networking management system as set forth in claim 12 further comprising a policy editing tool connected to the server for communicating policy rules from an administrator to the server.

14. The policy-based networking management system as set forth in claim 11 wherein the network subscriber is a network end-user selected from the group consisting of personal computers, virtual private networks and mobile hosts.

15. The policy-based networking management system as set forth in claim 11 wherein the PEA and the PS run on same network protocols.

16. The policy-based networking management system as set forth in claim 11 wherein the PEA and the PS employ a first and a second network protocol respectively and the PEA policy communication means includes translating means for converting the policy request in the first network protocol to instructions in second network protocol.

17. The policy-based networking management system as set forth in claim 16 wherein the translating means are loaded into the PEA by Remote Method Invocation.

18. The policy-based networking management system as set forth in claim 11 wherein the system employs TCP/IP, the PEA further comprising TCP bypassing means to communicate the policy request or the policy rule directly between the PEA and the network node.

19. The policy-based networking management system as set forth in claim 18 wherein the TCP bypassing means includes means for establishing a persistent connection between the PEA and the network node.

20. The policy-based networking management system as set forth in claim 11 wherein the means for communicating the policy rule to the PS includes a module server system comprising policy conversion modules for translating policy request from a network protocol native to the network node to a network protocol understandable by the PS.

21. The policy-based networking management system as set forth in claim 11 wherein the policy repository includes QoS requirements for network subscribers in neighboring policy domains.

22. The policy-based networking management system as set forth in claim 11 wherein the PEA includes load balancing means.

23. The policy-based networking management system as set forth in claim 11 wherein the policy-based networking management system employs one of the DiffServ architecture and the IntServ architecture.

24. The policy-based networking management system as set forth in claim 11 wherein the PEA further includes means for dynamically recognizing neighboring policy administrative domains.

25. The policy-based networking management system as set forth in claim 11 wherein the PEA further includes network parameters monitoring means for redirecting policy activity to less active policy server.

26. The policy-based networking management system as set forth in claim 25 wherein the network parameters monitoring means includes one of a Weighted Round Robin scheme on a Class-based Queuing.

27. A computer-readable medium carrying one or more sequences of instructions for managing a network according to a plurality of network management policies, the computer-readable medium comprising:
means for establishing bi-directional policy communication between a policy server and a network node;
means for validating a policy request from a network node;
means for accessing the policy server to fetch a policy rule corresponding to the policy request; and
means for translating the policy rule into machine language understandable by the network node.

28. A unified policy-driven network management system comprising:
a policy server having a plurality of pre-stored policy instructions defining QoS performance at a network node;
means for establishing a bi-directional policy session between the policy server and the network node through a policy enforcement agent (PEA), the PEA having means for intercepting a policy request initiated by the network node, the PEA having further means for fetching a policy rule corresponding to the policy request by the network node, and means for enforcing the policy rule at the network node.
